(19) United States
(12) Patent Application Publication
(10) Pub. No.: US 2007/0052759 A1
(43) Pub. Date: Mar. 8, 2007

(54) INKJET PRINTHEAD AND METHOD OF MANUFACTURING THE SAME

(76) Inventors: Yong-shik PARK, Seongnam-si (KR); Sung-joon Park, Suwon-si (KR); Myong-jong Kwon, Suwon-si (KR); Jin-wook Lee, Seoul (KR)

Correspondence Address: STANZIONE & KIM, LLP, 919 18TH STREET, N.W., SUITE 440, WASHINGTON, DC, 20006, US

(21) Appl. No.: 11/469,577

(22) Filed: Sep. 1, 2006

(30) Foreign Application Priority Data
Sep. 3, 2005 (KR) 2005-82002

(51) Int. Cl. B41J 2/05

(52) U.S. Cl. 347/61

(57) ABSTRACT

An inkjet printhead includes a substrate including a plurality of restrictors formed in an upper surface thereof and an ink feedhole formed in a lower surface thereof, a chamber layer stacked on the substrate and comprising a plurality of ink chambers corresponding to the plurality of restrictors including ink to be ejected, wherein each of the ink chambers is formed on an upper portion of a corresponding one of the restrictors and is connected to the corresponding one of the restrictors, a plurality of heaters formed on a bottom surface of corresponding ones of the plurality of ink chambers to heat the ink therein to generate bubbles, and a nozzle layer stacked on the chamber layer and comprising nozzles to eject the ink.

### CROSS-REFERENCE TO RELATED APPLICATIONS

This application claims priority under 35 U.S.C. §119(a) from Korean Patent Application No. 10-2005-0082002, filed on Sep. 3, 2005, in the Korean Intellectual Property Office, the disclosure of which is incorporated herein in its entirety by reference.

### BACKGROUND OF THE INVENTION

1. Field of the Invention

The present general inventive concept relates to a inkjet printhead and a method of manufacturing the same, and more particularly, to a thermal inkjet printhead having good ink ejection characteristics to perform high quality and high speed printing, and a method of manufacturing of the same.

2. Description of the Related Art

An inkjet printhead ejects ink droplets on desired positions of recording paper in order to print predetermined color images. Inkjet printheads are classified into two types according to an ink droplet ejection mechanism thereof: a thermal inkjet printhead and a piezoelectric inkjet printhead. The thermal inkjet printhead ejects ink droplets due to an expansion force of bubbles generated by thermal energy. The piezoelectric inkjet printhead ejects ink droplets by a pressure applied to the ink due to a deformation of a piezoelectric body.

The ink droplet ejection mechanism of the thermal inkjet printhead is as follows. When a current flows through a heater made of a heating resistor, the heater is heated and ink near the heater in an ink chamber is instantaneously heated to about 300° C. Accordingly, bubbles are generated by ink evaporation, and the generated bubbles expand and exert a pressure on the ink filled in the ink chamber. Thereafter, an ink droplet is ejected through a nozzle out of the ink chamber.

According to a relationship between a growing direction of the bubble and an ejecting direction of the ink droplet, the thermal inkjet printheads are classified into a top-shooting type, a side-shooting type, and a back-shooting type. In the top-shooting type, the growing direction of the bubble and the ejecting direction of the ink droplet are the same. In the side-shooting type, the ejecting direction of the ink droplet is perpendicular to the growing direction of the bubble. In the back-shooting type, the ejecting direction of the ink droplet is opposite to the growing direction of the bubble.

Generally, the thermal inkjet printhead should satisfy the following criteria. A manufacturing process thereof should be simple, inexpensive, and allow mass production. To print high-resolution images, a distance between the nozzles in the thermal inkjet printhead should be as small as possible without generation cross-talk between adjacent nozzles. In other words, a plurality of nozzles should be densely arranged to increase a number of dots per inch (DPI). To print at high-speed, a time interval to refill the ink in the ink chamber should be very short, that is, a driving frequency of the printhead should be increased.

FIGS. 1A and 1B are a perspective view and a cross-sectional view, respectively, illustrating a conventional thermal inkjet printhead. Referring to FIGS. 1A and 1B, the conventional thermal inkjet printhead includes a substrate 10 having an ink feedhole 22 for supplying ink, a chamber layer 14 stacked on the substrate 10 and having an ink chamber 26 where ink 29 to be ejected is filled and an ink inlet 24, a heater 12 disposed on a bottom of the ink chamber 26, and a nozzle layer 18 stacked on the chamber layer 14 and having a nozzle 16 ejecting an ink droplet 29′ from the ink chamber 26. When a pulse type current is supplied to the heater 12 to generate heat, the ink 29 filled in the ink chamber 26 is heated to generate a bubble 28. The bubble 28 continuously expands, and thus presses the ink 29 filled in the ink chamber 26 to thereby eject the ink droplet 29′ from the nozzle 16. Next, the ink 29 is supplied from the ink feedhole 22 through the ink inlet 24 to the ink chamber 26.

In the above described inkjet printhead, the heater 12 is surrounded by three inner walls of the ink chamber 26 (in addition to a bottom surface thereof) formed in the chamber layer 14 but not surrounded from a direction of the ink feedhole 22, i.e., a side of the heater 12 facing the ink feedhole that is not surrounded by and does not face an inner wall of the ink chamber 26 formed in the chamber layer 14. Accordingly, the bubble 28, which is generated by the heater 12 and pushes the ink 29 toward the nozzle 16, also pushes the ink 29 toward the ink feedhole 22, i.e., the bubble 28 generates a backward ink flow. The backward ink flow may result in an insufficient pressure to eject the ink 29, and thus the ink 29 may not be properly ejected, thereby degrading printing quality. In addition, cross-talk between adjacent ink chambers 26 may occur. To reduce the backward ink flow, a restrictor to increase a flow resistance may be disposed in the ink inlet 24. However, the restrictor may create a problem regarding a supply of the ink 29 from the ink feedhole 22 to the ink chamber 26 after the ink 29 is ejected, which decreases a driving frequency of the printhead. Therefore, an inkjet printhead which can decrease the backward ink flow due to bubble growth, smoothly supply ink, and prevent cross-talk between adjacent ink chambers is required.

### SUMMARY OF THE INVENTION

The present general inventive concept provides a thermal inkjet printhead having good ink ejection characteristics to perform high quality and high speed printing, and a method of manufacturing of the same.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet printhead, including a substrate comprising a plurality of restrictors formed in an upper surface thereof, and an ink feedhole formed in a lower surface thereof to communicate with the plurality of restrictors, a chamber layer stacked on the substrate and comprising a plurality of ink chambers corresponding to the plurality of restrictors including ink to be ejected, each of the ink chambers formed on an upper portion of a corresponding one of the restrictors and connected to the corresponding one of the restrictors, a plurality of heaters formed on a bottom surface of corresponding ones of the plurality of ink chambers to heat the ink therein to generate bubbles, and a nozzle layer stacked on the chamber layer and comprising nozzles to eject the ink.

Each of the restrictors may be disposed between adjacent ones of the heaters. Each of the restrictors may be disposed between one of the heaters and the ink feedhole.

A common ink passage may be formed between the ink feedhole and the restrictors to connect the ink feedhole and the restrictors. A bottom surface of the common ink passage and a bottom surface of the restrictors may be located on a same plane as the lower surface of the substrate.

A maximum distance between an inner wall of each ink chamber and the corresponding heater may be about 25 μm or less.

The foregoing and/or other aspects and utilities of the present general inventive concept may also be achieved by providing a method of manufacturing an inkjet printhead, including forming a plurality of restrictors in an upper surface of a substrate, forming an ink feedhole in a lower surface of the substrate to communicate with the plurality of restrictors, depositing a chamber layer on the substrate, the chamber layer comprising a plurality of ink chambers corresponding to the plurality of restrictors including ink to be ejected, each of the ink chambers formed on an upper portion of a corresponding one of the restrictors and connected to the corresponding one of the restrictors, forming a plurality of heaters on a bottom surface of corresponding ones of the plurality of ink chambers to heat the ink therein to generate bubbles, and depositing a nozzle layer on the chamber layer, the nozzle layer comprising nozzles to eject the ink.

The foregoing and/or other aspects and utilities of the present general inventive concept may also be achieved by providing a method of manufacturing an inkjet printhead, including forming a plurality of heaters on an upper surface of a substrate, forming a trench to a predetermined depth in the upper surface of the substrate, the trench to include a plurality of restrictors corresponding to the plurality of heaters, filling a first sacrificial layer in the trench, depositing a chamber layer having ink chambers on the upper surface of the substrate and an upper surface of the first sacrificial layer to expose the heaters and the first sacrificial layer filled in the restrictors of the trench, depositing a nozzle layer having nozzles on an upper surface of the chamber layer, forming an ink feedhole to expose the first sacrificial layer in a lower surface of the substrate, and forming the plurality of restrictors.

The forming of the restrictors may include etching the first sacrificial layer exposed through the nozzles, the ink chambers, and the ink feedhole.

The depositing of the nozzle layer includes: filling a second sacrificial layer in the ink chamber; and depositing the nozzle layer, which includes the nozzles exposing the second sacrificial layer, on the upper surface of the chamber layer and the second sacrificial layer.

The forming of the restrictors may include etching the first and second sacrificial layers exposed through the ink feedhole and the nozzles, respectively.

The foregoing and/or other aspects and utilities of the present general inventive concept may also be achieved by providing a printhead, including a substrate, a chamber layer formed on the substrate, a nozzle layer formed on the chamber layer, an ink chamber formed in the chamber layer between the substrate and the nozzle layer, a heater formed on the substrate to correspond to the ink chamber, a restrictor formed in the substrate to communicate with the ink chamber, and an ink feedhole formed in the substrate to communicate with the restrictor. The ink chamber may have a first width in a direction perpendicular to an ink flow direction along the restrictor, and the restrictor may have a second width that is narrower than the first width.

The foregoing and/or other aspects and utilities of the present general inventive concept may also be achieved by providing a printhead, including a substrate having an upper surface, a lower surface, and a bottom surface, an ink chamber formed on the upper surface of the substrate, and including a nozzle to eject ink from the ink chamber and a bottom surface defined by the upper surface of the substrate, an ink feedhole formed in the lower surface of the substrate to supply ink to the ink chamber, a heating unit formed on the upper surface of the substrate in the ink chamber to heat the ink in the ink chamber, and a restrictor formed in the substrate to connect the ink feedhole and the ink chamber and having a bottom surface defined by the lower surface of the substrate.

The upper surface of the substrate may be in a first plane, and the lower surface of the substrate may be in a second plane that is substantially-parallel to the first plane. The restrictor may include a first end connected to the ink feedhole, and a second end connected to the ink chamber, and the heating unit may be disposed a predetermined distance from the second end of the restrictor. The heating unit may disposed at a first position on the bottom surface of the ink chamber, and the first end of the restrictor may connect to a second position on the bottom surface of the ink chamber a predetermined distance from the first position.

The restrictor may be disposed under the bottom surface of the ink chamber to supply the ink up to the ink chamber. The heating unit may be surrounded by four sides of the ink chamber and the bottom surface of the ink chamber. The ink chamber may be disposed on a first plane, and the restrictor may be disposed on a second plane that is parallel to the first plane. The ink chamber may extend in a direction perpendicular to the restrictor. The ink chamber may extend in a direction parallel to the restrictor. The ink chamber may be longer than the restrictor. The ink chamber may be shorter than the restrictor. The ink chamber may be wider than the restrictor. The ink chamber may be narrower than the restrictor. The second surface may be separated from the first surface by a predetermined depth.

The foregoing and/or other aspects and utilities of the present general inventive concept may also be achieved by providing a method of manufacturing a printhead, including forming an ink chamber on an upper surface of a substrate to include a nozzle to eject ink from the ink chamber and a bottom surface defined by the upper surface of the substrate, forming an ink feedhole in a lower surface of the substrate to supply ink to the ink chamber, forming a heating unit on the upper surface of the substrate in the ink chamber to heat the ink in the ink chamber, and forming a restrictor in the substrate to connect the ink feedhole and the ink chamber and to have a bottom surface defined by the lower surface of the substrate.

The method may further include forming a trench in the upper surface of the substrate to form the lower surface of the substrate. The forming of the trench may include etching the upper surface of the substrate to a predetermined depth to form the lower surface of the substrate.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A and 1B are a perspective view and a cross-sectional view, respectively, illustrating a conventional thermal inkjet printhead;

FIG. 2 is a schematic perspective view illustrating an inkjet printhead according to an embodiment of the present general inventive concept;

FIG. 3 is a schematic plan view illustrating the inkjet printhead of FIG. 2;

FIG. 4 is a cross-sectional view taken along line A-A′ of FIG. 3;

FIG. 5 a schematic perspective view illustrating an inkjet printhead according to another embodiment of the present general inventive concept;

FIG. 6 is a schematic plan view illustrating the inkjet printhead of FIG. 5;

FIG. 7 is a cross-sectional view taken along line B-B′ of FIG. 6;

FIG. 8A through 13B are views illustrating a method of manufacturing the inkjet printhead of FIG. 2 according to an embodiment of the present general inventive concept; and

FIG. 14A through 19B are views illustrating a method of manufacturing the inkjet printhead of FIG. 5 according to an embodiment of the present general inventive concept.

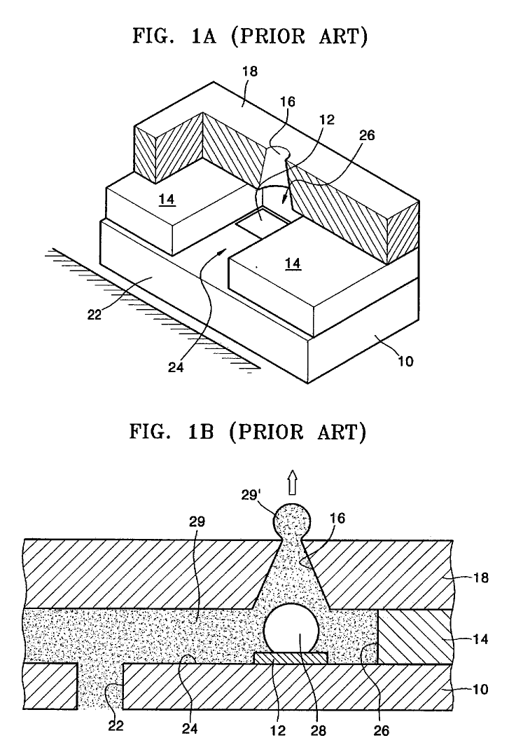

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

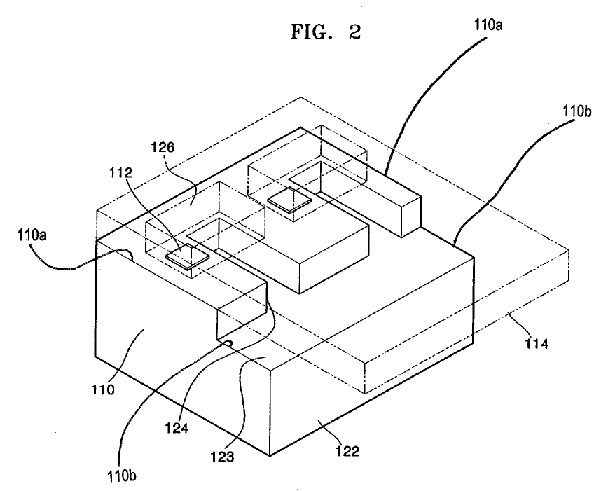

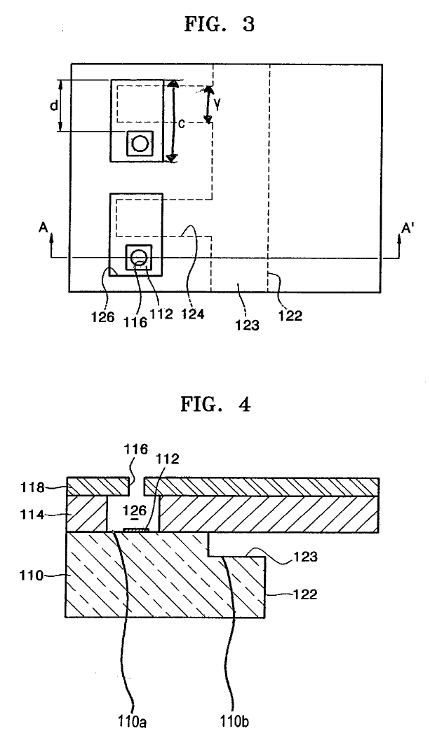

FIG. 2 is a schematic perspective view illustrating an inkjet printhead according to an embodiment of the present general inventive concept. FIG. 3 is a schematic plan view illustrating the inkjet printhead of FIG. 2. FIG. 4 is a cross-sectional view taken along line A-A′ of FIG. 3.

Referring to FIGS. 2 through 4, a plurality of heaters 112 to heat ink to generate bubbles are formed on an upper surface 110a of a substrate 110. The substrate 110 may be, for example, a silicon wafer. The heaters 112 may be heating resistors made of, for example, a tantalum-aluminum alloy, titanium nitride, and/or tungsten silicide. Although not illustrated, conductors to supply a pulse type current to the heaters 112 may be formed on the upper surface 110a of the substrate 110. The conductors may be made of, for example, a metal having good electric conductivity, such as aluminum, an aluminum alloy, gold, or silver.

A plurality of restrictors 124 corresponding to the heaters 112 are formed in the upper surface of the substrate 110. Each of the restrictors 124 is disposed between adjacent heaters 112. An ink feedhole 122 to supply the ink to the restrictors 124 is formed through the substrate 110. A common ink passage 123 connecting the ink feedhole 122 and the restrictors 124 is formed between the restrictors 124 and the ink feedhole 122. A bottom of the common ink passage 123 and a bottom of the restrictors 124 are disposed on a same plane as a lower surface 110b of the substrate 110.

A chamber layer 114 having a plurality of ink chambers 126 is stacked on the substrate 110 having the restrictors 124 and the ink feedhole 122. Each of the plurality of ink chambers 126 disposed on the chamber layer 114 is connected to a corresponding one of the restrictors 124. Each of the ink chambers 126 is disposed on an upper portion of the corresponding one of the restrictors 124. Specifically, a portion of a bottom of the ink chamber 126 is connected to a restrictor 124 and another portion of the ink chamber 126 has the heater 112. A maximum distance d between the inner wall and the heater 112 in the ink chamber 126 may be about 25 μm or less. A nozzle layer 118 is stacked on the chamber layer 114 having the ink chambers 126. The nozzle layer 118 has a plurality of nozzles 116 in communication with the ink chambers 126. Each of the nozzles 116 is disposed on an upper portion of a corresponding one of the ink chambers 126.

As illustrated in FIG. 3, a width c of the ink chamber 126 may be greater than a width γ of the corresponding one of the restrictors 124. In addition, the width c of the ink chamber 126 may be greater than the maximum distance d between the inner wall and the heater 112 in the ink chamber 126, and the maximum distance d may be greater than the width γ of the corresponding one of the restrictors 124. However, the present general inventive concept is not so limited. For example, the width c the ink chamber 126 may be smaller (i.e., narrower) than or equal to the width γ of the corresponding one of the restrictors 124. Furthermore, the width c of the ink chamber 126 may be smaller than or equal to the maximum distance d between the innerwall and the heater 112 in the ink chamber 126. In addition, the maximum distanced between the inner wall and the heater 112 in the ink chamber 126 may be smaller than or equal to the width γ of the corresponding one of the restrictors 124.

In the above described inkjet printhead, each of the heaters 112 is surrounded by four inner walls of the ink chamber 126 (in addition to a bottom surface thereof) formed in the chamber layer 114, and each of the restrictors 124 formed on the substrate 110 is disposed under the lower portion of the ink chamber 126 to supply ink to the ink chamber 126. Accordingly, the inkjet printhead according to the present embodiment can prevent backward ink flow, that is, can prevent the ink in the ink chamber 126 from being pushed toward the ink feedhole 122 due to the bubble formation, thereby increasing an ejecting speed of an ink droplet. In addition an occurrence of cross-talk between adjacent ink chambers 126 can be prevented. Also, the ink can be smoothly supplied from the ink feedhole 122 through the common ink passage 123 and the restrictors 124 to the ink chambers 126 after ink ejection, thereby increasing a driving frequency of the printhead. Although FIGS. 2-4 illustrate the nozzle 116 disposed on a top surface of the ink chamber 126, the present general inventive concept is not so limited. For example, the nozzle 116 may be disposed on a side wall of the ink chamber 126, in which case each of the heaters 112 is surrounded by three inner walls of the ink chamber 126, in addition to top and bottom surfaces thereof. In other words, even when the nozzle 116 is disposed at a position other than the top surface of the ink chamber 126, each of the heaters 112 is entirely surrounded by the ink chamber except for at the location of the nozzle 116.

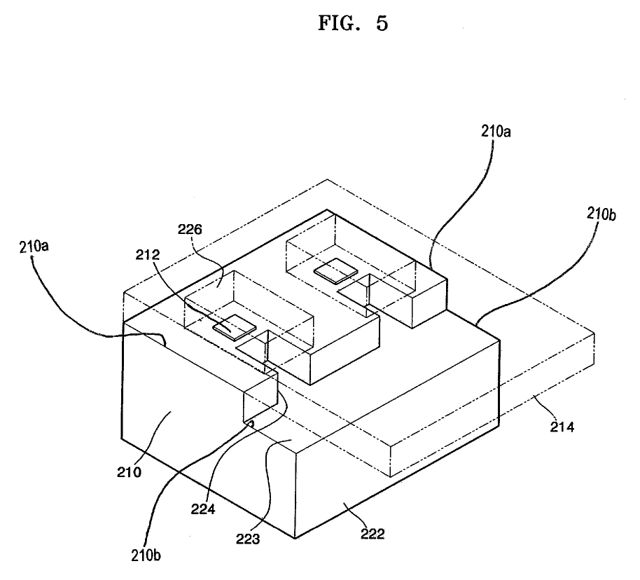

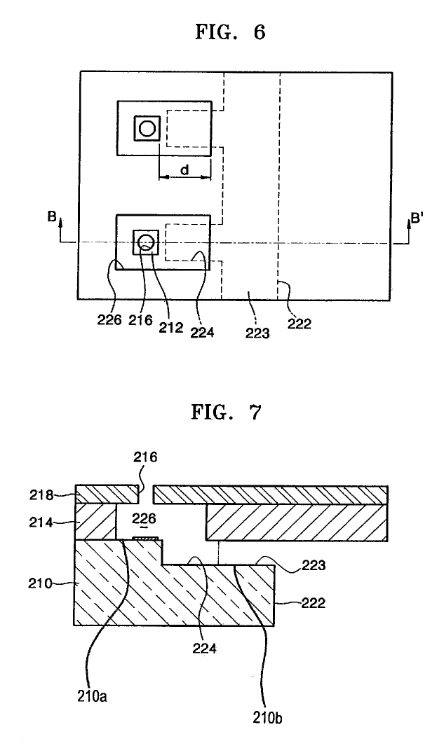

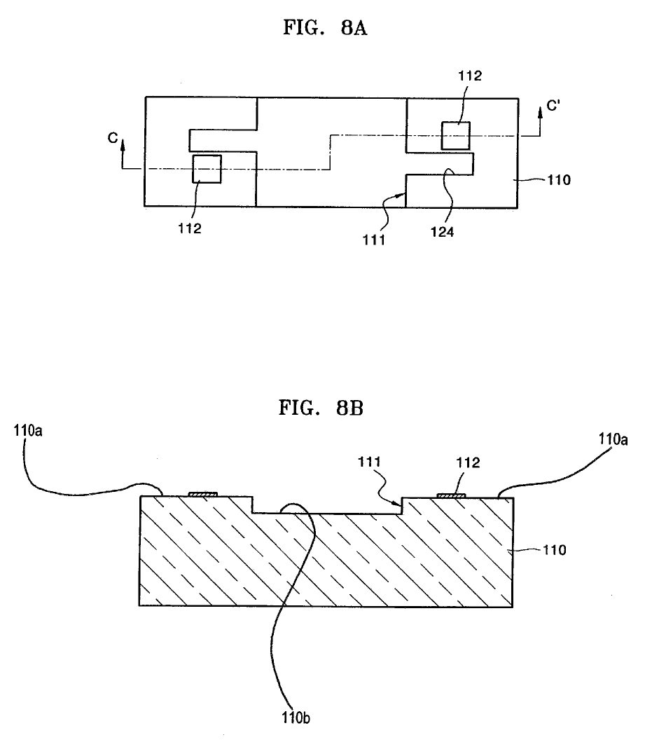

FIG. 5 a schematic perspective view illustrating an inkjet printhead according to another embodiment of the present general inventive concept. FIG. 6 is a schematic plan view illustrating the inkjet printhead of FIG. 5. FIG. 7 is a cross-sectional view taken along line B-B′ of FIG. 6. Hereinafter, differences from the previous embodiment illustrating in FIGS. 2-4 will be mainly described.

Referring to FIGS. 5 through 7, a plurality of heaters 212 are formed on an upper surface 210a of a substrate 210. Although not illustrated, conductors to supply a pulse type current to the heaters 212 may be formed on the upper surface of the substrate 210.

A plurality of restrictors 224 corresponding to the heaters 212 are formed in the upper surface 210a of the substrate 210. An ink feedhole 222 to supply ink to the restrictors 224 is formed through the substrate 210. Each of the restrictors 224 is disposed between the heater 212 and the ink feedhole 222, unlike the previous restrictors 124 of FIGS. 2-4. A common ink passage 223 connecting the ink feedhole 222 and the restrictors 224 is formed between the restrictors 224 and the ink feedhole 222. A bottom of the common ink passage 223 and a bottom of the restrictors 224 are disposed on a same plane as a lower surface 110b of the substrate 210.

A chamber layer 214 having a plurality of ink chambers 226 is stacked on the substrate 210 having the restrictors 224 and the ink feedhole 222. Each of the ink chambers 226 is disposed on the upper portion of a corresponding one of the restrictor 224. Specifically, a portion of a bottom of the ink chamber 226 is connected to the corresponding restrictor 224 and another portion of the ink chamber 226 has the heater 212. A maximum distance d between an inner wall and the heater 212 in the ink chamber 226 may be about 25 μm or less. A nozzle layer 218 is stacked on the chamber layer 214 having the ink chambers 226. The nozzle layer 218 has a plurality of nozzles 216 in communication with the ink chambers 226. Each of the nozzles 216 is disposed on an upper portion of each of the ink chambers 226.

In the above described inkjet printhead, each of the heaters 212 is surrounded by four inner walls of the ink chamber 226 (in addition to a bottom surface thereof) formed in the chamber layer 214, and each of the restrictors 224 formed on the substrate 210 is disposed under a lower portion of the ink chamber 226 to supply ink to the ink chamber 226. Accordingly, the inkjet printhead according to the present embodiment has high ink ejection characteristics, similar to the inkjet printhead of the previous embodiment illustrated in FIGS. 2-4. Although FIGS. 5-7 illustrate the nozzle 216 disposed on a top surface of the ink chamber 226, the present general inventive concept is not so limited. For example, the nozzle 216 may be disposed on a side wall of the ink chamber 226, in which case each of the heaters 212 is surrounded by three inner walls of the ink chamber 226, in addition to top and bottom surfaces thereof. In other words, even when the nozzle 216 is disposed at a position other than the top surface of the ink chamber 226, each of the heaters 212 is entirely surrounded by the ink chamber except for at the location of the nozzle 216.

The ink ejection ability of the inkjet printhead of FIG. 5, according to the present embodiment of the present general inventive concept, was compared with that of a conventional printhead by computer simulation. The results are as follows. A driving frequency, an ejecting droplet speed, and a droplet volume of the conventional inkjet printhead were 18 kHz, 13 m/s, and 4.5 pl, respectively. A driving frequency, an ejecting droplet speed, and a droplet volume of the inkjet printhead of the present embodiment were 25 kHz, 14.7 m/s, and 4.4 pl, respectively. As apparent from the above, the driving frequency and the ejecting droplet speed of the inkjet printhead of the present embodiment are higher than those of the conventional inkjet printhead, and the droplet volumes for both printheads are similar. The driving frequency indicates how quickly an ink chamber is refilled with ink after ink ejection. The ejecting droplet speed can increase a moving speed of an inkjet printhead, thereby increasing a printing speed. In addition, as the driving frequency and the ejecting droplet speed increase, an amount of required ink droplets can be reduced. Therefore, the inkjet printhead of the present embodiment can realize high quality and high-speed printing due to the increase of the driving frequency and ejecting droplet speed thereof.

Hereinafter, methods of manufacturing an inkjet printhead according to embodiments of the present general inventive concept will be described.

FIG. 8A through 13B are views illustrating a method of manufacturing the inkjet printhead of FIG. 2 according to an embodiment of the present general inventive concept.

FIG. 8A is a plan view illustrating a state when heaters 112 are formed in an upper surface 110a of a substrate 110 and a trench 111 having a predetermined shape is formed in the upper surface 110a of the substrate 110 thereby forming a lower surface 110b on the substrate 110. As illustrated in FIG. 8B, the upper surface 110a is on a first plane and the lower surface 110b is on a second plane that is substantially-parallel to the first plane. FIG. 8b is a cross-sectional view taken along line C-C′. The substrate 110 may be a silicon wafer, but the present general inventive concept is not limited thereto. The heaters 112 may be heating resistors formed by forming a thin film tantalum-aluminum alloy, titanium nitride, and/or tungsten silicide on the upper surface of the substrate 110 and patterning the thin film. The trench 111 may be formed by etching the upper surface of the substrate 110 to a predetermined depth.

The trench 111 is formed to have a plurality of restrictors 124 corresponding to the heaters 112 and a common ink passage 123 connecting the restrictors 124 and an ink feedhole 122. Each of the restrictors 124 is disposed between adjacent heaters 112.

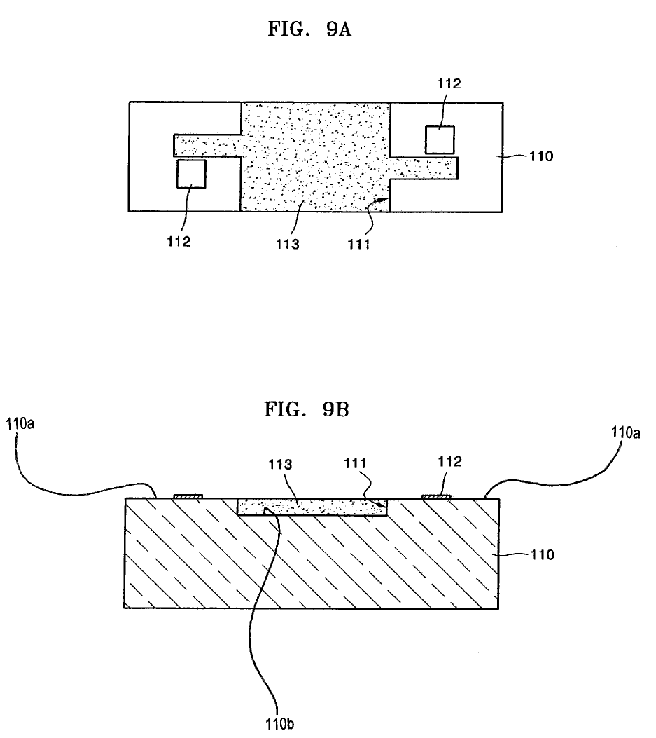

FIG. 9A is a plan view illustrating a state when the trench 111 formed in the substrate 110 is filled with a first sacrificial layer 113 made of a predetermined material. FIG. 9B is a cross-sectional view of FIG. 9A. The first sacrificial layer 113 may be polysilicon. Specifically, an epitaxial growth of polysilicon may be performed on the substrate 110 to fill in the trench 111, and then an upper surface of the polysilicon is planarized using a chemical mechanical polishing (CMP) process. Accordingly, the upper surface 110a of the substrate 110 is exposed.

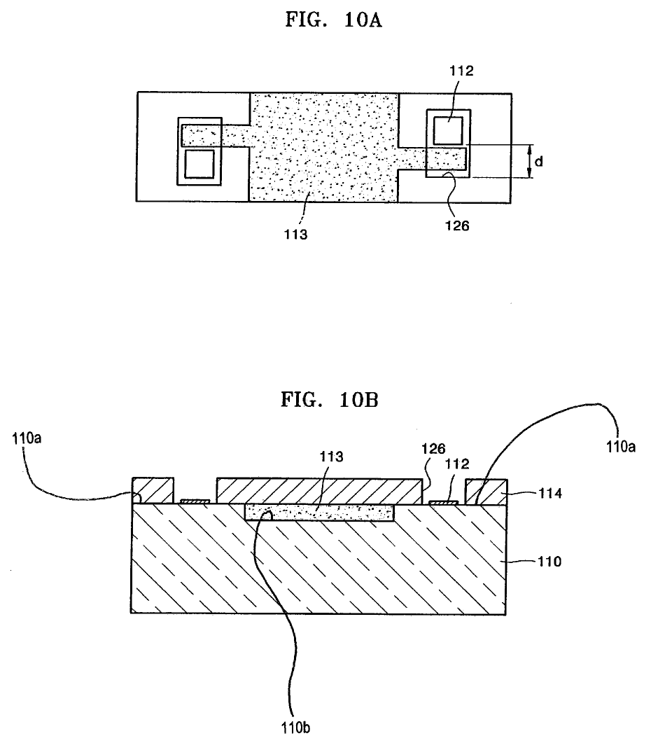

FIG. 10A is a plan view illustrating a state when a chamber layer 114 having ink chambers 126 is formed on the upper surface 110a of the substrate 110 and an upper surface of the first sacrificial layer 113. FIG. 10B is a cross-sectional view of FIG. 10A. The heaters 112 and the restrictors 124 adjacent to the heaters 112 in the trench 111 are exposed through the ink chambers 126 in the chamber layer 114. The ink chamber 126 may be formed to have a maximum distance of about 25 μm or less between an inner wall of the ink chamber 126 and the heater 112. Specifically, the chamber layer 114 may be formed by stacking a photosensitive resin on the upper surface 110a of the substrate 110 and the upper surface of the first sacrificial layer 113 and patterned using, for example, lithography. Meanwhile, the chamber layer 114 may be formed by stacking a film having the ink chambers 126 on the upper surface 100a of the substrate 110 and the upper surface of the first sacrificial layer 113.

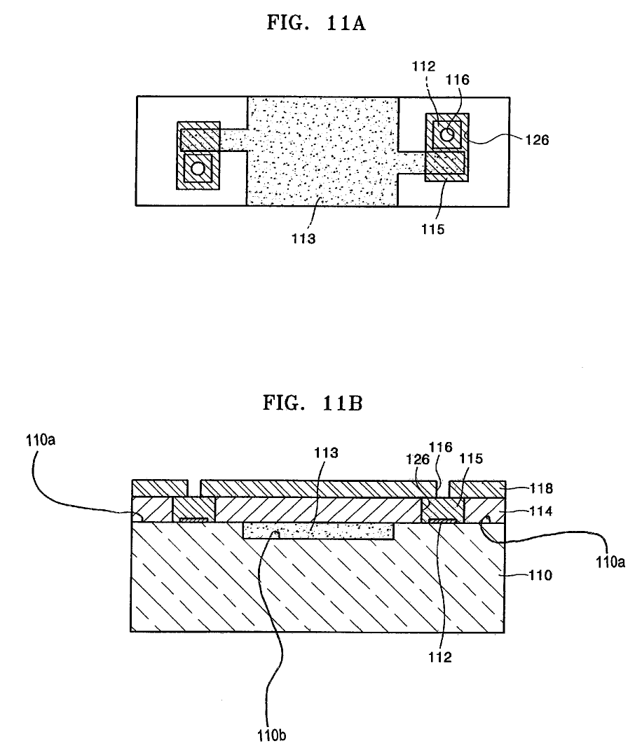

FIG. 11A is a plan view illustrating a state when a nozzle layer 118 having nozzles 116 is formed on an upper surface of the chamber layer 114. FIG. 11B is a cross-sectional view of FIG. 11A. Specifically, a second sacrificial layer 115 is filled in the ink chambers 126 disposed in the chamber layer 114. A photosensitive resin is stacked on upper surfaces of the chamber layer 114 and the second sacrificial layer 115 and patterned to form the nozzle layer 118 which includes the nozzles 116 exposing the second sacrificial layer 115. The nozzle layer 118 may be formed by stacking a film having the nozzles 116 on the chamber layer 114.

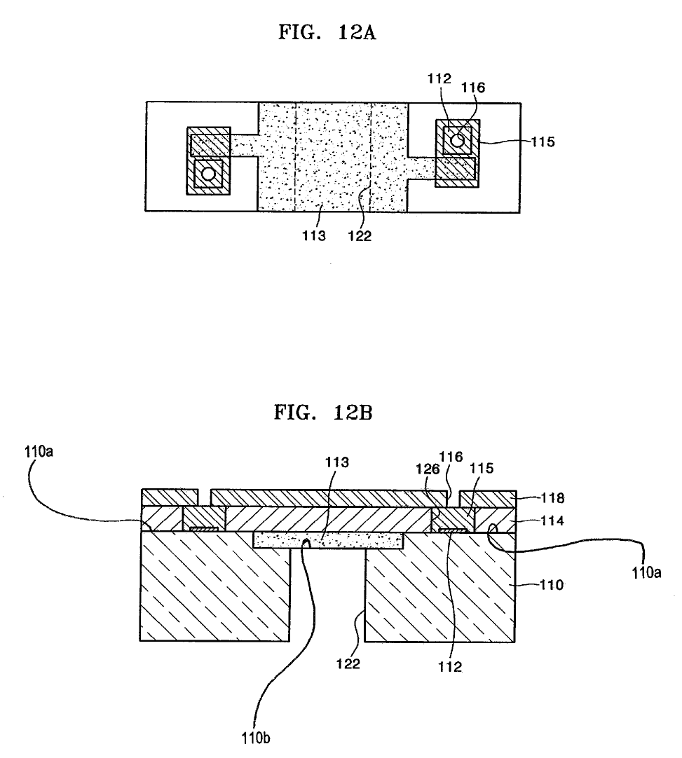

FIG. 12A is a plan view illustrating a state when the ink feedhole 122 exposing the first sacrificial layer 113 is formed on the lower surface 110b of substrate 110. FIG. 12B is a cross-sectional view of FIG. 12A. The ink feedhole 122 is formed by dry or wet etching the lower surface 110b of the substrate 110 until the first sacrificial layer 113 is exposed.

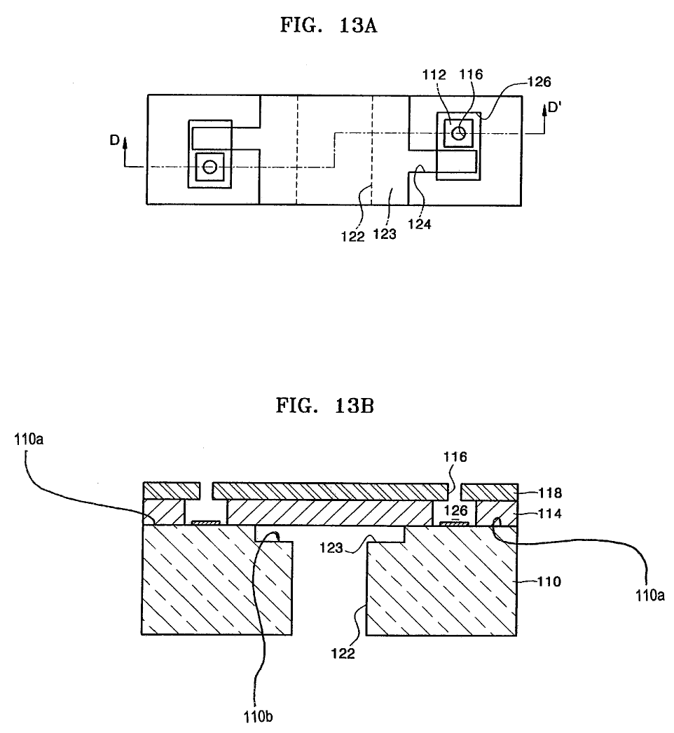

The first sacrificial layer 113 exposed through the ink feedhole 122 and the second sacrificial layer 115 exposed through the nozzles 116 are removed by etching, and thus the ink chambers 126, the restrictors 124, and the common ink passage 123 are formed between the nozzles 116 and the ink feedhole 122. FIG. 13A is a plan view illustrating the inkjet printhead formed by the method according to the present embodiment. FIG. 13B is a cross-sectional view taken along line D-D′ of FIG. 13A.

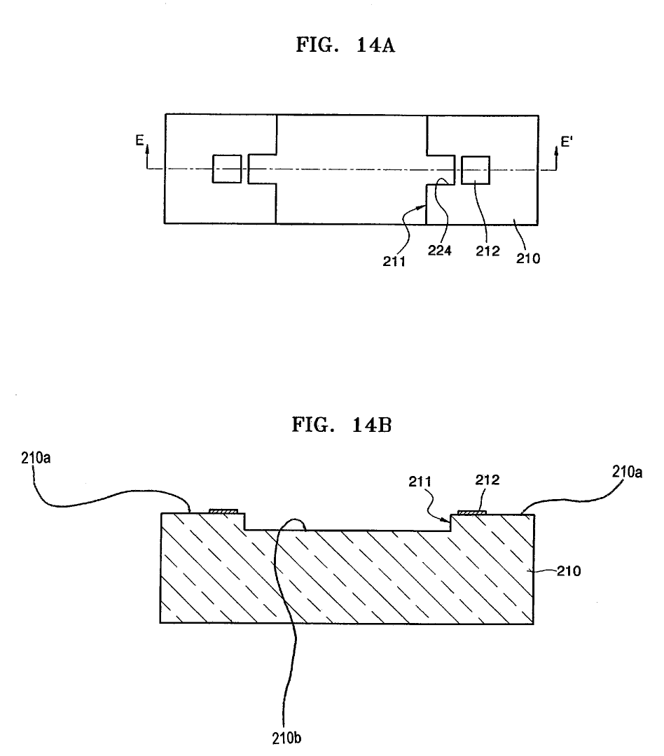

FIG. 14A through 19B are views illustrating a method of manufacturing the inkjet printhead of FIG. 5 according to an embodiment of the present general inventive concept. Hereinafter, differences from the previous embodiment illustrated in FIGS. 8A-13B will be mainly described.

FIG. 14A is a plan view illustrating a state when a heater 212 is formed on an upper surface of a substrate 210 and a trench 211 having a predetermined shape is formed in the upper surface of the substrate 210 thereby forming a lower surface 210b on the substrate 210. As illustrated in FIG. 14B, the upper surface 210a is on a first plane and the lower surface 210b is on a second plane that is substantially-parallel to the first plane. FIG. 14B is a cross-sectional view taken along line E-E′ of FIG. 14A. The trench 211 is formed to have a plurality of restrictors 224 corresponding to the heaters 212 and a common ink passage 223 connecting the restrictors 224 and an ink feedhole 222. Each of the restrictors 224 is disposed between each of heaters 212 and the ink feedhole 222.

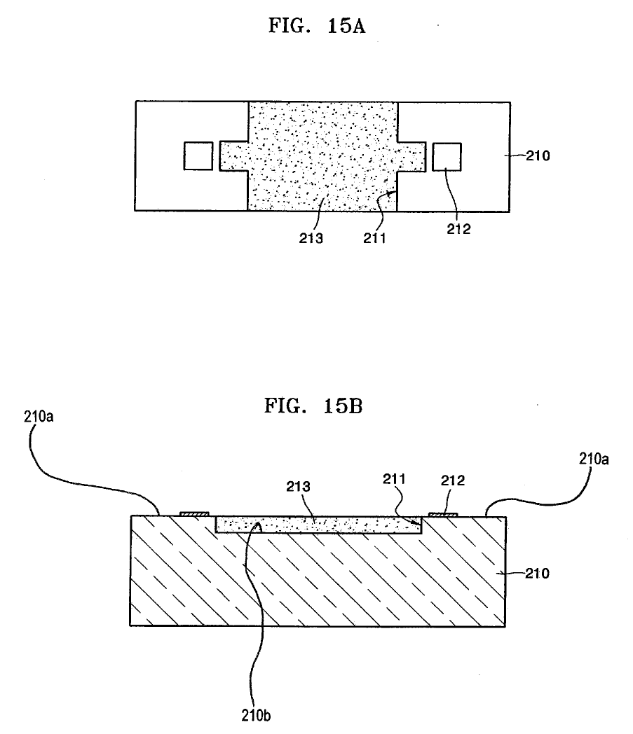

FIG. 15A is a plan view illustrating a state when the trench 211 formed in the substrate 210 is filled with a first sacrificial layer 213 made of a predetermined material. FIG. 15B is a cross-sectional view of FIG. 15A. The first sacrificial layer 213 may be polysilicon.

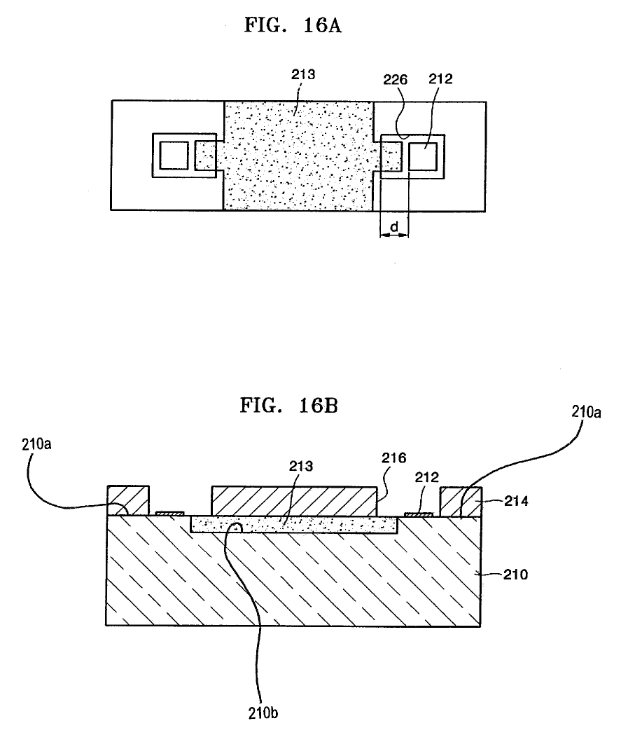

FIG. 16A is a plan view illustrating a state when a chamber layer 214 having ink chambers 226 is formed on the upper surface 210a of the substrate 210 and an upper surface of the first sacrificial layer 213. FIG. 16B is a cross-sectional view of FIG. 16A. The heaters 212 and the restrictors 224 adjacent to the heaters 212 in the trench 211 are exposed through the ink chambers 226 in the chamber layer 214. The ink chamber 226 may be formed to have a maximum distance of about 25 μm or less between an inner wall of the ink chamber 226 and the heater 212.

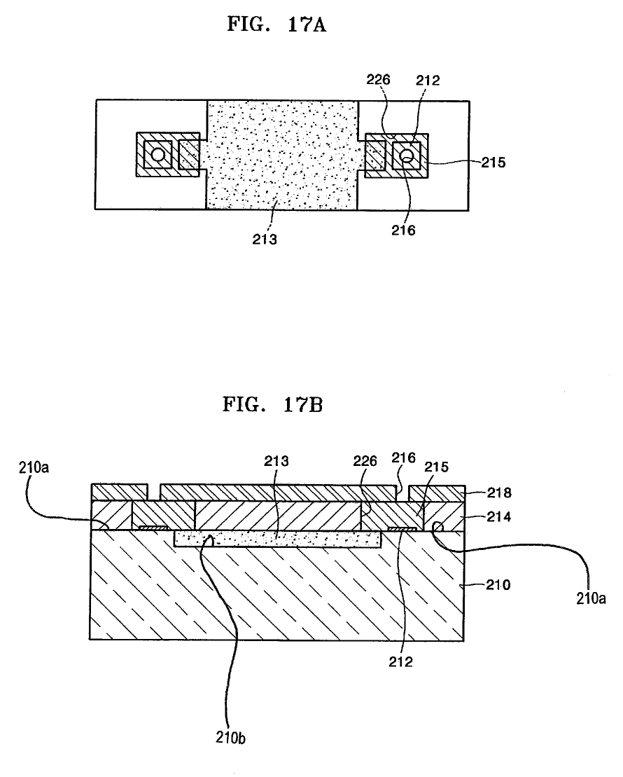

FIG. 17A is a plan view illustrating a state when a nozzle layer 218 having nozzles 216 is formed on an upper surface of the chamber layer 214. FIG. 17B is a cross-sectional view of FIG. 17A. Specifically, a second sacrificial layer 215 is filled in the ink chambers 226 disposed in the chamber layer 214. A photosensitive resin is stacked on upper surfaces of the chamber layer 214 and the second sacrificial layer 215 and patterned to form the nozzle layer 218, which includes the nozzles 216 exposing the second sacrificial layer 215.

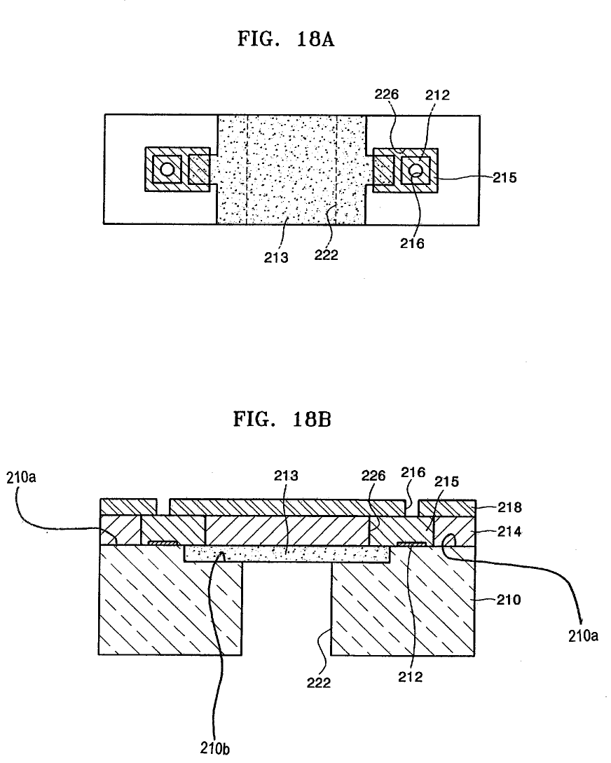

FIG. 18A is a plan view illustrating a state when the ink feedhole 222 exposing the first sacrificial layer 213 is formed in the lower surface 210b of substrate 210. FIG. 18B is a cross-sectional view of FIG. 18A. The ink feedhole 222 is formed by dry or wet etching the lower surface 210b of the substrate 210 until the first sacrificial layer 213 is exposed.

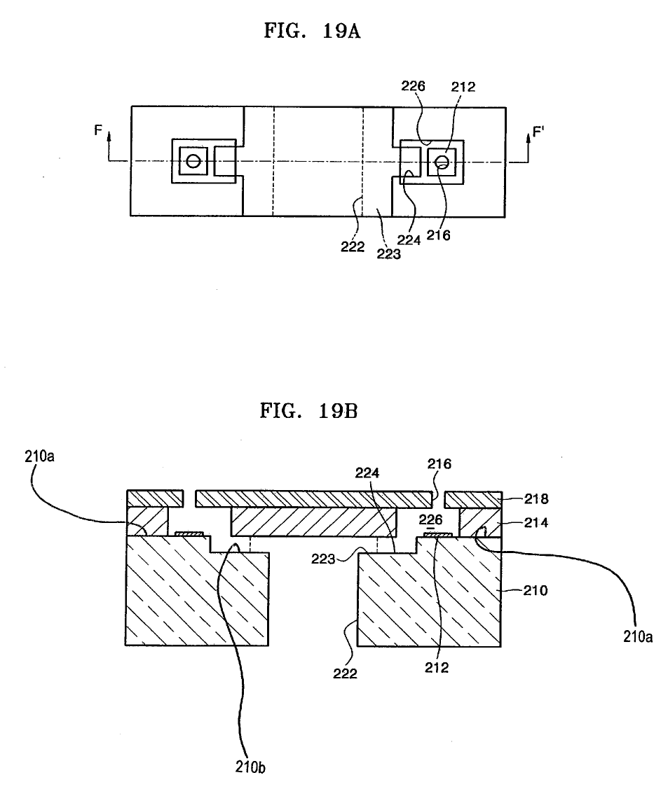

The first sacrificial layer 213 exposed through the ink feedhole 222 and the second sacrificial layer 215 exposed through the nozzles 216 are removed by etching, and thus the ink chambers 226, the restrictors 224, and the common ink passage 223 are formed between the nozzles 216 and the ink feedhole 222. FIG. 19A is a plan view illustrating the inkjet printhead formed by the method according to the present embodiment. FIG. 19B is a cross-sectional view taken along line F-F′ of FIG. 19A.

In an inkjet printhead according to various embodiments of the present general inventive concept, each heater is surrounded by four inner walls of an ink chamber (in addition to a bottom surface thereof) formed in a chamber layer, and each restrictor of the inkjet printhead formed on a substrate is disposed under a lower portion of the ink chamber to supply ink to the ink chamber. For example, each heater may be formed on an upper surface of the substrate on a first plane, and a bottom of the restrictor may be formed on a lower surface of the substrate on a second plane that is substantially-parallel to the first plane. Accordingly, the inkjet printhead can prevent backward ink flow. In particular, ink in the ink chamber is pushed toward an ink feedhole due to bubbles formed when ink is ejected, thereby enhancing ink ejection characteristics. Specifically, an occurrence of cross-talk between adjacent ink chambers can be prevented when the ink is ejected, and an ejecting speed of an ink droplet can be increased. In addition, refill ink is smoothly supplied from the ink feedhole through each restrictor to the ink chambers after the ink is ejected, thereby increasing a driving frequency of the printhead. Consequently, high quality and high speed printing can be realized.

The present general inventive concept may, however, be embodied in many different forms and should not be construed as being limited to the embodiments set forth herein. It will also be understood that when a layer is referred to as being “on” another layer or a substrate, it can be directly on the other layer or the substrate, or indirectly on the other layer or the substrate, such as through intervening layers. Moreover, an operation order in the methods of manufacturing an inkjet printhead according to embodiments of the present general inventive concept may vary from those described above.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printhead comprising:
a substrate comprising a plurality of restrictors formed in an upper surface thereof, and an ink feedhole formed in a lower surface thereof to communicate with the plurality of restrictors;
a chamber layer stacked on the substrate and comprising a plurality of ink chambers corresponding to the plurality of restrictors including ink to be ejected, each of the ink chambers formed on an upper portion of a corresponding one of the restrictors and connected to the corresponding one of the restrictors;
a plurality of heaters formed on a bottom surface of corresponding ones of the plurality of ink chambers to heat the ink therein to generate bubbles; and
a nozzle layer stacked on the chamber layer and comprising nozzles to eject the ink.

2. The inkjet printhead of claim 1, wherein each of the restrictors is disposed between adjacent ones of the heaters.

3. The inkjet printhead of claim 1, wherein each of the restrictors is disposed between one of the heaters and the ink feedhole.

4. The inkjet printhead of claim 1, wherein a common ink passage is formed between the ink feedhole and the restrictors to connect the ink feedhole and the restrictors.

5. The inkjet printhead of claim 4, wherein a bottom surface of the common ink passage and a bottom surface of the restrictors are located on a same plane as the lower surface of the substrate.

6. The inkjet printhead of claim 1, wherein a maximum distance between an inner wall of each ink chamber and the corresponding heater is about 25 μm or less.

7. A method of manufacturing an inkjet printhead, comprising:
forming a plurality of heaters on an upper surface of a substrate;
forming a trench to a predetermined depth in the upper surface of the substrate, the trench to include a plurality of restrictors corresponding to the plurality of heaters;
filling a first sacrificial layer in the trench;
depositing a chamber layer having ink chambers on the upper surface of the substrate and an upper surface of the first sacrificial layer to expose the heaters and the first sacrificial layer filled in the restrictors of the trench;
depositing a nozzle layer having nozzles on an upper surface of the chamber layer;
forming an ink feedhole to expose the first sacrificial layer in a lower surface of the substrate; and
forming the plurality of restrictors.

8. The method of claim 7, wherein the restrictors are disposed between adjacent ones of the heaters.

9. The method of claim 7, wherein the restrictors are disposed between each of the heaters and the ink feedhole.

10. The method of claim 7, wherein the trench comprises:
a common ink passage connecting the restrictors and the ink feedhole.

11. The method of claim 7, wherein, a maximum distance between an inner wall of each ink chamber and the corresponding heater is about 25 μm or less.

12. The method of claim 7, wherein the forming of the restrictors comprises:
etching the first sacrificial layer exposed through the nozzles, the ink chambers, and the ink feedhole.

13. The method of claim 7, wherein the depositing of the nozzle layer comprises:
filling a second sacrificial layer in the ink chamber; and
depositing the nozzle layer, which includes the nozzles exposing the second sacrificial layer, on the upper surface of the chamber layer and the second sacrificial layer.

14. The method of claim 13, wherein the forming of the restrictors comprises:
etching the first and second sacrificial layers exposed through the ink feedhole and the nozzles, respectively.

15. A printhead, comprising:
a substrate;
a chamber layer formed on the substrate;
a nozzle layer formed on the chamber layer;
an ink chamber formed in the chamber layer between the substrate and the nozzle layer;
a heater formed on the substrate to correspond to the ink chamber;
a restrictor formed in the substrate to communicate with the ink chamber; and
an ink feedhole formed in the substrate to communicate with the restrictor.

16. The printhead of claim 15, wherein the ink chamber has a first width in a direction perpendicular to an ink flow direction along the restrictor, and the restrictor has a second width that is narrower than the first width.

17. A printhead, comprising:
a substrate having an upper surface, a lower surface, and a bottom surface;
an ink chamber formed on the upper surface of the substrate, and including a nozzle to eject ink from the ink chamber and a bottom surface defined by the upper surface of the substrate;
an ink feedhole formed in the lower surface of the substrate to supply ink to the ink chamber;
a heating unit formed on the upper surface of the substrate in the ink chamber to heat the ink in the ink chamber; and
a restrictor formed in the substrate to connect the ink feedhole and the ink chamber and having a bottom surface defined by the lower surface of the substrate.

18. The printhead of claim 17, wherein the upper surface of the substrate is in a first plane, and the lower surface of the substrate is in a second plane that is substantially-parallel to the first plane.

19. The printhead of claim 17, wherein the restrictor comprises:
a first end connected to the ink feedhole; and
a second end connected to the ink chamber,
wherein the heating unit is disposed a predetermined distance from the second end of the restrictor.

20. The printhead of claim 17, wherein the restrictor comprises:
a first end connected to the ink feedhole; and
a second end connected to the ink chamber,
wherein the heating unit is disposed at a first position on the bottom surface of the ink chamber, and the first end of the restrictor connects to a second position on the bottom surface of the ink chamber a predetermined distance from the first position.

21. The printhead of claim 17, wherein the restrictor is disposed under the bottom surface of the ink chamber to supply the ink up to the ink chamber.

22. The printhead of claim 17, wherein the ink chamber is disposed on a first plane, and the restrictor is disposed on a second plane that is parallel to the first plane.

23. The printhead of claim 17, wherein the heating unit is surrounded by four sides of the ink chamber and the bottom surface of the ink chamber.

24. The printhead of claim 17, wherein the ink chamber extends in a direction perpendicular to the restrictor.

25. The printhead of claim 17, wherein the ink chamber extends in a direction parallel to the restrictor.

26. The printhead of claim 17, wherein the ink chamber is longer than the restrictor.

27. The printhead of claim 17, wherein the ink chamber is shorter than the restrictor.

28. The printhead of claim 17, wherein the ink chamber is wider than the restrictor.

29. The printhead of claim 17, wherein the ink chamber is narrower than the restrictor.

30. The printhead of claim 17, wherein the second surface is separated from the first surface by a predetermined depth.

31. A method of manufacturing a printhead, comprising:
forming an ink chamber on an upper surface of a substrate to include a nozzle to eject ink from the ink chamber and a bottom surface defined by the upper surface of the substrate;
forming an ink feedhole in a lower surface of the substrate to supply ink to the ink chamber;
forming a heating unit on the upper surface of the substrate in the ink chamber to heat the ink in the ink chamber; and
forming a restrictor in the substrate to connect the ink feedhole and the ink chamber and to have a bottom surface defined by the lower surface of the substrate.

32. The method of claim 31, further comprising:
forming a trench in the upper surface of the substrate to form the lower surface of the substrate.

33. The method of claim 31, wherein the forming of the trench comprises:
etching the upper surface of the substrate to a predetermined depth to form the lower surface of the substrate.
